(19) United States
(12) Patent Application Publication
(10) Pub. No.: US 2023/0148022 A1
(43) Pub. Date: May 11, 2023

(54) ENABLING OF DISPLAY OF A MUSIC VIDEO FOR ANY SONG

(71) Applicant: Magic Media Works Limited t/a ROXi, London (GB)

(72) Inventors: Rob LEWIS, London (GB); William MORGAN, London (GB)

(73) Assignee: Magic Media Works Limited t/a ROXi, London (GB)

(21) Appl. No.: 17/979,478

(22) Filed: Nov. 2, 2022

(30) Foreign Application Priority Data
Nov. 5, 2021 (GB) 2115936.3

(51) Int. Cl. G10H 1/36; H04N 21/235; G06F 16/58

(52) U.S. Cl. CPC G10H 1/368; H04N 21/235; G06F 16/58; G10H 2220/005

(57) ABSTRACT

A system is provided for enabling a music video streaming service to display a music video for any song is provided. The system preferably includes a music video archive, including songs having associated regular music videos in the form of single audiovisual assets including visual content; a song archive, comprising songs in the form of single audiovisual assets which do not include any visual content, i.e. that do not have associated regular music videos; an image archive, including images having metadata that associate the images with artists of songs featured in the song archive; and at least one processing device, arranged to, when a song from the song archive is selected to be played on the music video streaming service, automatically and in real-time create a music video for the song, in the form of a video slide-show, using images from the image archive.

### CROSS-REFERENCE TO RELATED APPLICATIONS

This application claims benefit of United Kingdom Application No. 2115936.3, filed Nov. 5, 2021, which contents are incorporated herein in their entirety by reference.

### TECHNICAL FIELD

The present disclosure relates generally to enabling a music video streaming service to display a music video for any song.

### BACKGROUND

A regular music video is created by making a film that matches a song, i.e. a music video file that has been recorded, produced and delivered by a music label as a single audiovisual asset where all video content is pre-synchronised with the song. The creation of regular music videos is quite expensive, and many songs have therefore not got a matching regular music video.

### PROBLEMS WITH THE PRIOR ART

A music video streaming service may wish to allow the users to play songs with music videos (for the songs who have them), but also also songs that do not have regular music videos.

There is thus a need for a method of enabling a music video streaming service to display a music video for any song, i.e. also for audio only files that have been recorded, produced and delivered by a music label as a single audiovisual asset which does not comprise any visual content.

### SUMMARY

The above described problem is addressed by the claimed system and method for enabling a music video streaming service to display a music video for any song.

The claimed system may comprise: a music video archive, comprising songs having associated regular music videos in the form of single audiovisual assets comprising visual content; a song archive, comprising songs in the form of single audiovisual assets which do not comprise any visual content, i.e. that do not have associated regular music videos; an image archive, comprising images having metadata that associate the images with artists of songs featured in the song archive; and at least one processing device, arranged to, when a song from the song archive is selected to be played on the music video streaming service, automatically and in real-time create a music video for the song, in the form of a video slide-show, using images from the image archive.

The claimed method may comprise: creating a music video archive comprising songs having associated regular music videos in the form of single audiovisual assets comprising visual content; creating a song archive comprising songs in the form of single audiovisual assets which do not comprise any visual content, i.e that do not have associated regular music videos; creating an image archive comprising images having metadata that associate the images with artists of songs featured in the song archive; and, when a song from the song archive is selected to be played on the music video streaming service, automatically and in real-time creating a music video for the song, in the form of a video slide-show, using images from the image archive.

This enables a music video streaming service to display a music video for any song, i.e. also for audio only files that have been recorded, produced and delivered by a music label as a single audiovisual asset which does not comprise any visual content.

If the image archive comprises images having metadata that associate the images with the artist of the song, these images are in embodiments used to create the music video for the song. This makes the created music video appear more like a regular music video.

In embodiments, the image archive is created based on play data specifying how much the songs of each artist has been played on the music video streaming service, so that the image archive will always comprise images having metadata that associate them with at least the most played artists. This ensures that most of the music videos that are played will comprise images of the artist, and thus appear more like regular music videos.

In embodiments, the image archive also comprises general images having metadata associating the images to e.g. genres, eras and/or locations, and if there are no images associated with the artist of the song in the image archive, the at least one processing device is arranged to create the music video by selecting images based on metadata of the song, such as e.g. genre, era and/or location. This enables the creation of a music video that has at least some association with the song, even if there are no images associated with the artist of the song in the image archive.

In embodiments, the images in the image archive have been automatically selected, using an algorithm. The algorithm may be a machine learning algorithm, or an algorithm that is programmed to search for images associated with the artists in the song archive, and/or images associated with e.g. certain genres, eras and/or locations. The images in the image archive preferably have associated metadata that associate them with artists, genres, eras and/or locations.

In embodiments, the number of images in the music video is based on the tempo of the song, so that a slower song will have fewer images in the music video.

The term “artist of a song” in this application refers to the artist, in the form of an individual performer or a group of performers, who is given credit for performing the song. Normally, this is also the artist actually performing the song in the recording, but in some situations, an artist is given credit for a song that the artist is not actually performing. The “artist of a song” is nevertheless the artist that is listed by the music label as the artist of the song.

The term “regular music video” in this application refers to a music video in the form of a music video file that has been recorded, produced and delivered by a music label as a single audiovisual asset where all video content is pre-synchronised with the song. Regular music videos are typically official music videos created by the music label or record company. A song having an associated regular music video is thus a single audiovisual asset that comprises visual content.

The video slide-shows are typically not stored, but instead created in real-time each time a song from the song archive is selected to be played on the music video streaming service.

The at least one processing device may be one processing device, or a number of processing devices between which signals are transmitted. Some processing may e.g. take place in one processing device, and signals may then be transmitted to one or more other processing devices for further processing.

The user device may e.g. be a consumer electronic device, e.g. a portable communications device, such as e.g. a smartphone. The user device may also be any type of computer, or a television set, e.g. a smart TV, or a smart speaker.

The various modules of the system may be physically separate modules between which information is sent, but may also be virtual modules implemented on the same server, or simply software modules.

The scope of the invention is defined by the claims, which are incorporated into this section by reference. A more complete understanding of embodiments of the invention will be afforded to those skilled in the art, as well as a realization of additional advantages thereof, by a consideration of the following detailed description of one or more embodiments. Reference will be made to the appended sheets of drawings that will first be described briefly.

### BRIEF DESCRIPTION OF THE DRAWINGS

FIG. 1 schematically illustrates a system for enabling a music video streaming service to display a music video for any song, in accordance with one or more embodiments described herein.

FIG. 2 is an example of a user interface to a music video streaming service.

FIG. 3 is an example flow diagram of a method for enabling a music video streaming service to display a music video for any song, in accordance with one or more embodiments described herein.

FIG. 4 schematically illustrates a method for enabling a music video streaming service to display a music video for any song, in accordance with one or more embodiments described herein.

Embodiments of the present disclosure and their advantages are best understood by referring to the detailed description that follows. It should be appreciated that like reference numerals are used to identify like elements illustrated in one or more of the figures.

### DETAILED DESCRIPTION

The present disclosure relates to systems and methods for enabling a music video streaming service to display a music video for any song, i.e. also for audio only files that have been recorded, produced and delivered by a music label as a single audiovisual asset which does not comprise any visual content. Embodiments of the disclosed solution are presented in more detail in connection with the figures.

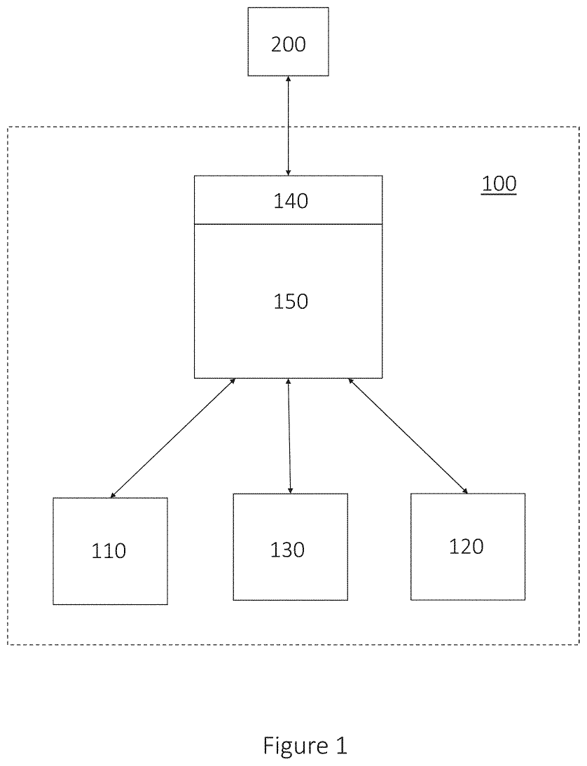

FIG. 1 schematically illustrates a system 100 for enabling a music video streaming service to display a music video for any song. The system 100 preferably comprises a music video archive 110, a song archive 120, an image archive 130, and at least one processing device 150. The at least one processing device 150 may e.g. be comprised in a server arrangement, which may be in the form of a distributed server, e.g. comprising a content delivery network (CDN).

The music video archive 110 is preferably arranged to comprise songs having associated regular music videos in the form of single audiovisual assets comprising visual content, and the song archive 120 is preferably arranged to comprise songs in the form of single audiovisual assets which do not comprise any visual content, i.e. that do not have associated regular music videos. The music video archive 110 and the song archive 120 may be arranged on the same storage means 140, possibly even in the same database arrangement, but there must be a clear indication that allows the least one processing device 150 to determine whether or not the song has an associated regular music video in the form of a single audiovisual asset comprising visual content. The system 100 may also comprise a user interface 140, via which a user using a user device 200 may select music videos to be played.

In order to enable the music video streaming service to display a music video for any song, the at least one processing device 150 is preferably arranged to, automatically and in real-time, create a music video for any song that is in the form of a single audiovisual asset which does not comprise any visual content, i.e. that does not have an associated regular music video. In order to do this, the least one processing device 150 uses images from the image archive 130, and creates the music video in the form of a video slide-show. The image archive 130 is preferably arranged to comprise images having metadata that associate them with the artists of the songs featured in the song archive 120. If the image archive 130 comprises images having metadata that associate them with the artist of the song, these images are preferably used to create the music video. This makes the created music video appear more like a regular music video.

However, it may not be possible to keep images having metadata that associate them with an artist for all artists featured in the song archive 120 in the image archive. The image archive 130 may therefore be created based on play data specifying how much the songs of each artist has been played on the music video streaming service, so that the image archive 130 will always at least comprise images having metadata that associate them with most played artists. This ensures that most of the music videos that are played will comprise images of the artist, and thus appear more like regular music videos.

The image archive 130 may be arranged to also comprise general images having metadata associating the images to e.g. genres, eras and/or locations. If there are no (or very few) images having metadata that associate them with the artist of the song in the image archive 130, the at least one processing device 150 may be arranged to create the music video by selecting images based on other types of metadata of the song, such as e.g. genre, era and/or location. This enables the creation of a music video that has at least some association with the song, even if there are no images associated with the artist of the song in the image archive 130. There may e.g. be images in the image archive 130 that are associated with 50's rock, so if a song has metadata that associates it with 50's rock, and there are no (or very few) images associated with the artist in the image archive 130, the at least one processing device 150 may be arranged to create the music video by selecting images having metadata that associates them with 50's rock. The music videos may of course comprise general images in combination with images of the artist even if there are enough images of the artist in the image archive 130.

The images in the image archive 130 may e.g. be downloaded from a commercial image database. In commercial image databases, the images often have associated metadata that associate them with e.g. artists, genres, eras and/or locations, as well as metadata specifying other factors such as e.g. the date, the colour makeup, and/or whether the image is in portrait or landscape form. It is therefore typically possible to search such commercial databases for images that are desired for the image archive 130, using metadata searching. When an image has been downloaded from a commercial image database, it may be desirable to process it before it is stored in the image archive 130. Processing such as e.g. zooming, cropping and/or changing the colour may be used in order for the image to fit better into a music video. It is preferably possible to add metadata to the general images in the image archive 130, to associate the general images with certain artists or genres.

In embodiments, the images in the image archive 130 have been automatically selected, using an algorithm. The algorithm may be a machine learning algorithm, or an algorithm that is programmed to search for images associated with the artists of the songs in the song archive 120, and/or images associated with e.g. certain genres, eras and/or locations. The images in the image archive 130 preferably have associated metadata that associate them with artists, genres, eras and/or locations.

In embodiments, the number of images in the music video is based on the tempo of the song, so that a slower song will have fewer images in the music video.

The video slide-shows are typically not stored, but instead created in real-time each time a song from the song archive 120 is selected to be played on the music video streaming service.

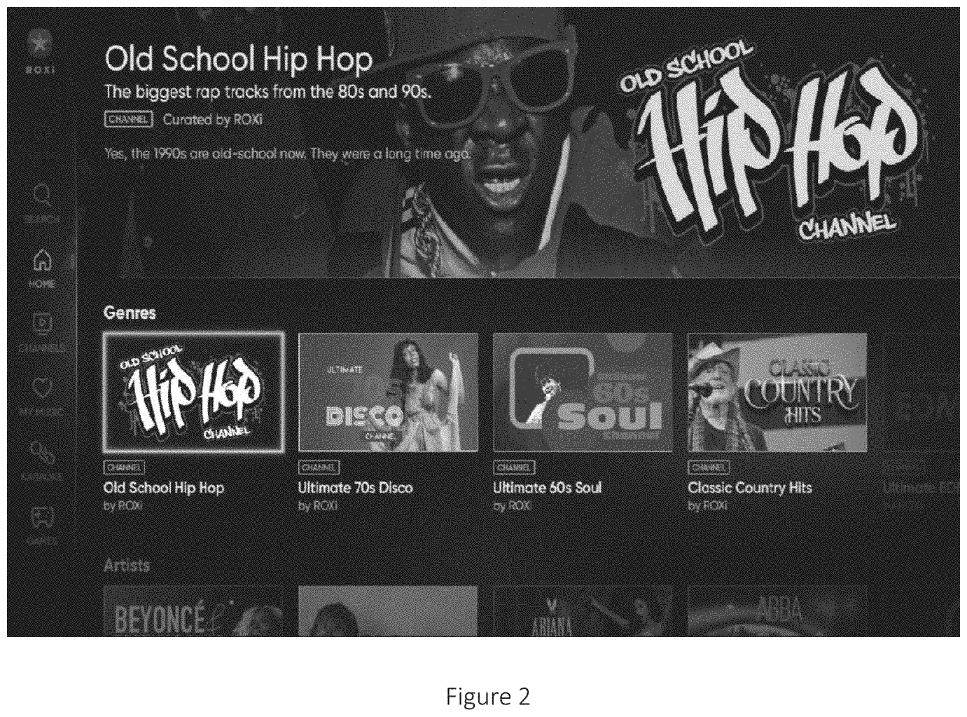

FIG. 2 is an example of a user interface 140 to the music video streaming service ROXi TV, where a user can select music videos to be played. It is not necessarily shown in the user interface whether there is a regular music video for the selected song, since a music video will otherwise be created in real-time. The selected music video will thus be displayed to the user via the user interface 140 regardless of whether or not there is a regular music video for the selected song.

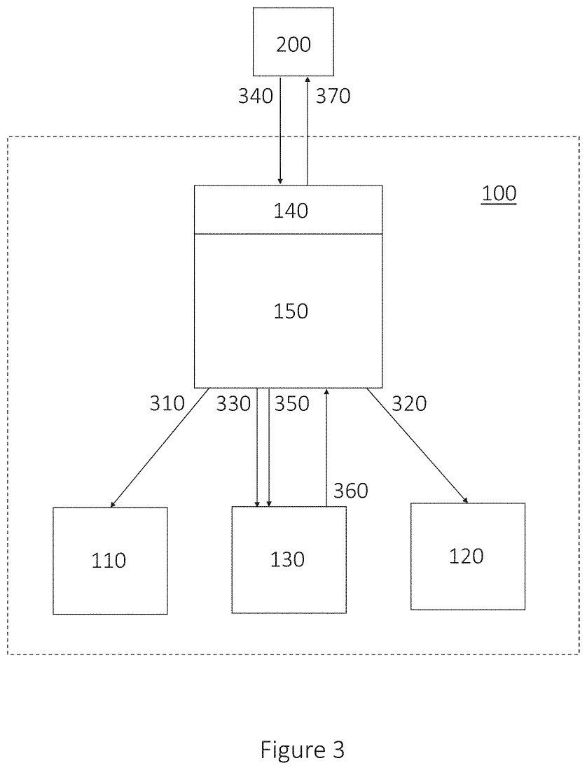

FIG. 3 is an example flow diagram of a method for enabling a music video streaming service to display a music video for any song, i.e. also for audio only files that have been recorded, produced and delivered by a music label as a single audiovisual asset which does not comprise any visual content. The flow is as follows:

Step 310: the at least one processing device 150 creates a music video archive 110 comprising songs having associated regular music videos in the form of single audiovisual assets comprising visual content.

Step 320: the at least one processing device 150 creates a song archive 120 comprising songs in the form of single audiovisual assets which do not comprise any visual content, i.e. that do not have associated regular music videos.

Step 330: the at least one processing device 150 creates an image archive 130, comprising images having metadata that associate the images with artists of songs featured in the song archive 120. This may involve the processing device 150 determining, based on play data, how much the songs of each artist has been played on the music video streaming service, and ensuring that the image archive 130 comprises images having metadata that associate them with at least the most played artists. This may also involve the processing device 150 adding general images having metadata associating the images to e.g. genres, eras and/or locations to the image archive 130.

Step 340: A user using a user device 200 selects, via the user interface 140, a music video to be played for a song in the song archive 120.

Step 350: The processing device 150 determines the artist of the song and requests images having metadata that associate them with that artist from the image archive 130.

Step 360: The image archive 130 provides the processing device 150 with the images of the artist. If there are no (or very few) images of the artist in the image archive 130, the image archive 130 instead, or additionally, provides the processing device 150 with images based on metadata of the song, such as e.g. genre, era and/or location.

Step 370: The processing device 150 automatically and in real-time creates a music video for the song, in the form of a video slide-show, using images provided by the image archive 130, and plays it to the user via the user interface 140 on the user device 200.

### Method Embodiments

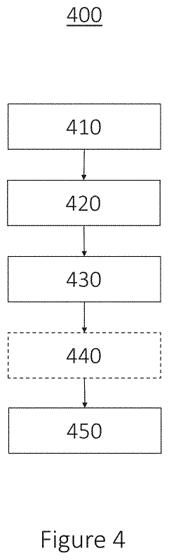

FIG. 4 schematically illustrates a method for enabling a music video streaming service to display a music video for any song, i.e. also for audio only files that have been recorded, produced and delivered by a music label as a single audiovisual asset which does not comprise any visual content. The method 400 may comprise:

Step 410: creating a music video archive 110 comprising songs having associated regular music videos in the form of single audiovisual assets comprising visual content.

Step 420: creating a song archive 120 comprising songs in the form of single audiovisual assets which do not comprise any visual content, i.e. that do not have associated regular music videos.

Step 430: creating an image archive 130 comprising images having metadata that associate the images with artists of the songs featured in the song archive 120.

Step 450: when a song from the song archive 120 is selected to be played on the music video streaming service, automatically and in real-time creating a music video for the song, in the form of a video slide-show, using images from the image archive 130.

In embodiments, if the image archive 130 comprises images having metadata that associated them with the artist of the song, these images are used in the creating 450 of the video slide-show. This makes the created music video appear more like a regular music video.

In embodiments, the creating 430 of the image archive 130 is based on play data specifying how much the songs of each artist has been played on the music video streaming service, so that the image archive 130 will always comprise images having metadata that associate them with at least the most played artists. This ensures that most of the music videos that are played will comprise images of the artist, and thus appear more like regular music videos.

In embodiments, the creating 430 of the image archive 130 comprises automatically selecting images, using an algorithm. The algorithm may be a machine learning algorithm, or an algorithm that is programmed to search for images associated with the artists in the song archive 120, and/or images associated with e.g. certain genres, eras and/or locations. The images in the image archive 130 preferably have associated metadata that associate them with artists, genres, eras and/or locations, as well as metadata specifying other factors such as e.g. the date, the colour makeup, and/or whether the image is in portrait or landscape form.

In embodiments, the creating 450 of the video slide-show involves selecting the number of images to use in the video slide-show based on the tempo of the song, so that a slower song will have fewer images in the video slide-show.

The method 400 may further comprise:

Step 440: adding general images having metadata associating the images to e.g. genres, eras and/or locations to the image archive 130, and if there are no images associated with the artist of the song in the image archive 130, the creating 450 of the video slide-show involves selecting images based on metadata of the song, such as e.g. genre, era and/or location. This enables the creation of a music video that has at least some association with the song, even if there are no images having metadata that associate them with the artist of the song in the image archive.

The foregoing disclosure is not intended to limit the present invention to the precise forms or particular fields of use disclosed. It is contemplated that various alternate embodiments and/or modifications to the present invention, whether explicitly described or implied herein, are possible in light of the disclosure. Accordingly, the scope of the invention is defined only by the claims.

Further, not all of the steps of the claims have to be carried out in the listed order. For example, steps 410, 420 and 430 may be carried out simultaneously, or in any order, as long as they have been carried out before step 450 is to be carried out. All technically meaningful orders of the steps are covered by the claims.

1. A system for enabling a music video streaming service to display a music video for any song, the system comprising:
a music video archive, comprising songs having associated regular music videos in the form of single audiovisual assets comprising visual content;
a song archive, comprising songs in the form of single audiovisual assets which do not comprise any visual content;
an image archive, comprising images having metadata that associate them images with artists of songs featured in the song archive; and
at least one processing device, arranged to, when a song from the song archive is selected to be played on the music video streaming service, automatically and in real-time create a music video for the song, in the form of a video slide-show, using images from the image archive.

2. The system according to claim 1, wherein if the image archive comprises images having metadata that associate them with the artist of the song, these images are used to create the music video for the song.

3. The system according to claim 1, wherein the image archive is created based on play data specifying how much the songs of each artist has been played on the music video streaming service, so that the image archive will always comprise images associated with at least the most played artists.

4. The system according to claim 1, wherein the image archive also comprises general images having metadata associating the images to the image archive, and if there are no images having metadata that associate them with the artist of the song in the image archive, the at least one processing device is arranged to create the music video by selecting images based on metadata of the song.

5. The system according to claim 1, wherein the images in the image archive have been automatically selected, using an algorithm.

6. The system according to claim 1, wherein the number of images in the music video is based on the tempo of the song, so that a slower song will have fewer images in the music video.

7. A method for enabling a music video streaming service to display a music video for any song, comprising:
creating a music video archive comprising songs having associated regular music videos in the form of single audiovisual assets comprising visual content;
creating a song archive comprising songs in the form of single audiovisual assets which do not comprise any visual content;
creating an image archive comprising images having metadata that associate the images with artists of songs featured in the song archive ; and
when a song from the song archive is selected to be played on the music video streaming service, automatically and in real-time creating a music video for the song, in the form of a video slide-show, using images from the image archive.

8. The method according to claim 7, wherein if the image archive comprises images having metadata that associate them with the artist of the song, these images are used in the creating of the music video for the song.

9. The method according to claim 7, wherein the creating of the image archive is based on play data specifying how much the songs of each artist has been played on the music video streaming service, so that the image archive will always comprise images associated with at least the most played artists.

10. The method according to claim 7, further comprising adding general images having metadata associating the images to the image archive, and if there are no images having metadata that associate them with the artist of the song in the image archive, the creating of the music video involves selecting images based on metadata of the song.

11. The method according to claim 7, wherein the creating of the image archive comprises automatically selecting images, using an algorithm.

12. The method according to claim 7, wherein the creating of the music video involves selecting the number of images to use in the music video based on the tempo of the song, so that a slower song will have fewer images in the music video.
